(19) United States
(12) Patent Application Publication
(10) Pub. No.: US 2021/0224490 A1
(43) Pub. Date: Jul. 22, 2021

(54) CONTENT LOCALIZATION FRAMEWORK

(71) Applicant: Microsoft Technology Licensing, LLC, Redmond, WA (US)

(72) Inventors: Jiwei Guo, Sunnyvale, CA (US); Sameer N. Mehra, San Francisco, CA (US); Yogesh M. Upadhyay, Milpitas, CA (US); Nelson Mei, San Leandro, CA (US)

(21) Appl. No.: 16/745,118

(22) Filed: Jan. 16, 2020

(51) Int. Cl. G06F 40/58; G06F 9/445; G06F 3/0484

(52) U.S. Cl. CPC G06F 40/58; G06F 3/0484; G06F 9/445

(57) ABSTRACT

The disclosed embodiments provide a system for managing the translation of content. During operation, the system generates a user interface for specifying parameters of a translation request for translating a content item from a first language into a second language. Next, the system formats the parameters and the content item into a representation of the translation request that is submitted for processing by a translation system. The system then monitors a status associated with processing the translation request by the translation system. Upon verifying completion of the translation request by the translation system, the system retrieves, from the translation system, a translation of the content item from the first language into the second language. Finally, the system formats the translation within a response to the translation request and transmits the response to a content source of the content item.

### BACKGROUND

### Field

The disclosed embodiments relate to content management. More specifically, the disclosed embodiments relate to a content localization framework for managing the translation of content.

### Related Art

Authors of articles, web pages, blogs, graphics, photos, audio, video, documents, reports, papers, and/or other digital content frequently use content management systems to create and publish the content. For example, a writer, developer, designer, researcher, and/or other type of author selects a template for creating a certain type of content within a content management system. Next, the author uses the template and features provided by the content management system to add text, images, audio, video, graphics, and/or other data to the content. After the author has finished creating the content, the author uses the content management system to publish the content to one or more servers, websites, and/or locations. The content management system also allows the author to track edits to and/or versions of the content, manage permissions associated with the content, search for the content, and/or perform other management related to the content.

Consequently, creation and distribution of digital content may be facilitated by improving the functionality and flexibility of content management systems.

### BRIEF DESCRIPTION OF THE FIGURES

FIG. 1 shows a schematic of a system in accordance with the disclosed embodiments.

FIG. 2 shows a content localization framework for managing the translation of content in accordance with the disclosed embodiments.

FIG. 3A shows an example screenshot in accordance with the disclosed embodiments.

FIG. 3B shows an example screenshot in accordance with the disclosed embodiments.

FIG. 4 shows a flowchart illustrating a process of managing the translation of content in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for managing content. For example, the content includes articles, posts, updates, messages, discussions, customer support tickets, help center articles, forms, jobs, advertisements, and/or other digital content items created by and/or delivered to users of an online system. Some or all of the content is created, managed, and/or distributed using a content management system.

More specifically, the disclosed embodiments provide a content localization framework for standardizing, tracking, and/or managing the translation of content. The content localization framework integrates with various content sources, including content management systems, content repositories, and/or external content sources. The content localization framework also interfaces with one or more translation systems that perform the translations. As a result, users are able to request and receive translations of content in any of the content sources through the content localization framework without learning to use the translation systems. In other words, the content localization framework provides a platform-agnostic link between various content sources and external translation systems.

To allow the users to generate requests for translating content, the content localization framework provides a user interface that can be used by the users to specify parameters of the requests. For example, the user interface includes user-interface elements for selecting content items to be translated, languages into which the content items are to be translated, priorities of the translations, translation methods to be used, and/or other parameters or settings associated with the translations.

After a translation request is submitted by the user via the user interface, the content localization framework converts the translation request into a format that can be processed by an external translation system that performs the translation based on the parameters of the translation request. For example, the content localization framework adds, to the request, structured data fields containing identifiers for the content item and request and one or more portions of the content item. The content localization framework also, or instead, stores the request in a file format that is accepted by the translation system.

The content localization framework then transmits the request to the translation system and monitors the status of the request. After the translation system has finished processing the request (e.g., after the requested translation has been generated), the content localization framework retrieves the translation from the translation system and provides the translation in a response to the original translation request. For example, the content localization framework generates a message containing the translation and transmits the message to the user that submitted the translation request and/or the content source of the original content item. The content localization framework and/or content source also store the translation in a location (e.g., path, directory, etc.) that is mapped to the language of the translation. When a resource request for the content item includes and/or is associated with the language, the content source determines the location of the translation based on the language and serves the translation from the location in response to the resource request.

By integrating with different types of content sources and translation systems, the content localization framework standardizes, streamlines, and automates the process of translating content from the content sources. Users are thus able to request and receive translations without interacting with and/or understanding how to use the translation systems. In turn, the content localization framework allows translations to be performed more quickly than conventional techniques that involve interacting with human translation managers and/or learning to use individual translation systems.

The content localization framework further reduces utilization of processor, memory, storage, network, and/or other resources by conventional techniques that require manual retrieval of content from a content source and/or extensive human interaction with translation systems to generate translation requests that can be processed by the translation systems. For example, a conventional technique involves a first human interacting with a user interface of a translation system to manually specify fields of a translation request, upload a content item to be translated, and submit the translation request. After the translation request is submitted, a second human interacts with the translation system to retrieve the translation request and upload a translation of the content item. The first human then conducts additional interaction with the translation system to determine when the translation is complete, retrieve the translation from the translation system, and store the translation in a location that allows the translation to be served to end users. In contrast, the content localization framework allows the first human to select a content item to be translated from a content source and/or automatically populates some or all fields of a translation request by the first human to translate the content item. The content localization framework then submits the content item and translation request to a translation system without requiring the first human to interact with the translation system, automatically retrieves the translation of the content item from the translation system, and provides the translation for review by the first human and/or automatically stores the translation in a location for subsequent serving to end users. Thus, the content localization framework reduces human interaction with the translation system and, in turn, the likelihood of errors and/or resource consumption in generating the user interface and/or processing requests from humans by the translation system. Consequently, the disclosed embodiments improve computer systems, applications, user experiences, tools, and/or technologies related to storing, processing, querying, managing, and/or translating content.

### Content Localization Framework

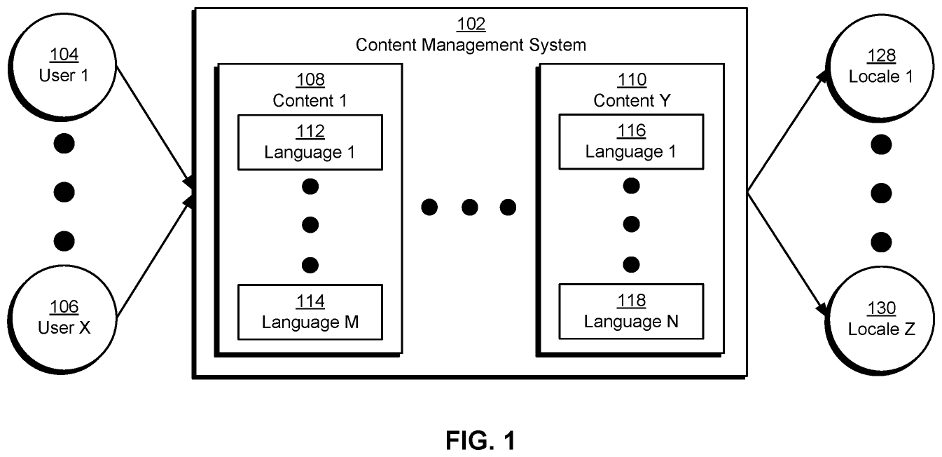

FIG. 1 shows a schematic of a system in accordance with the disclosed embodiments. As shown in FIG. 1, the system includes a content management system (CMS) 102 that is used by a set of users (e.g., user 1 104, user x 106) to produce a set of content (e.g., content 1 128, content z 130). For example, the users include writers, designers, illustrators, photographers, developers, musicians, architects, engineers, and/or other authors of digital content. The users interact with CMS 102 to create, update, and/or publish images, video, audio, multimedia, documents, articles, blogs, web pages, computer aided design (CAD) drawings, architectural designs, logos, papers, and/or other types of digital content.

Those skilled in the art will appreciate that content in CMS 102 may include languages that are familiar or native to users creating the content. For example, an online system that is used predominantly by users in English-speaking countries includes content in English that is created by English-speaking authors. As a result, a given piece of content in CMS 102 is translated into other languages (e.g., language 1 112 to language m 114 for content 1 108, language 1 116 to language n 118 for content y 110) to adapt the content to locales (e.g., locale 1 128, locale z 130) of other users. Continuing with the above example, English content in CMS 102 is translated into region-specific languages (e.g., different versions of French in France and Canada, different versions of Spanish in Spain and Latin America, etc.) to accommodate users that communicate using those languages.

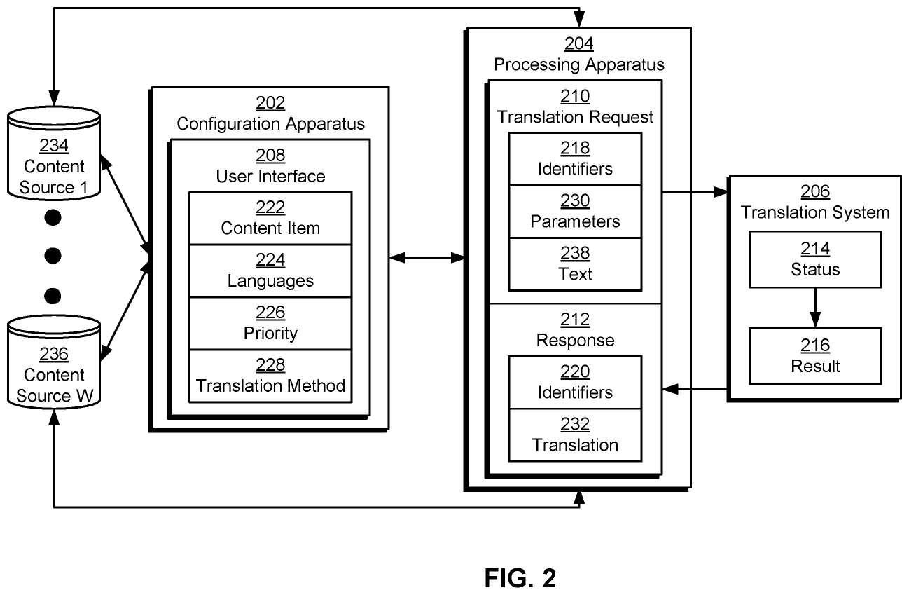

In one or more embodiments, translation of content in CMS 102 and/or other content sources is streamlined using a content localization framework that acts as an interface between the content sources and translation systems that perform the translations. As shown in FIG. 2, a content localization framework for managing the translation of content includes a configuration apparatus 202 and a processing apparatus 204. Each of these components is described in further detail below.

Configuration apparatus 202 provides a user interface 208 that allows users to specify parameters 230 of a translation request 210 for translating content in one or more content sources (e.g., content source 1 234, content source 236). For example, configuration apparatus 202 is provided by and/or includes functionality to interface with a CMS (e.g., CMS 102 of FIG. 1), database, distributed filesystem, web feed, website, external content source, and/or another source of content. In turn, user interface 208 includes a graphical user interface (GUI), web-based user interface, command line interface (CLI), voice user interface, and/or another type of interface that allows users to browse and/or search for content in the content sources and request translation of the content.

In one or more embodiments, parameters 230 used to request translation of content in the content sources include, but are not limited to, a content item 222, one or more languages 224, a priority 226, and a translation method 228. Content item 222 may include an article, post, document, file, message, web page, user profile, job posting, and/or another unit of text-based content. Content item 222 also, or instead, may include an image, audio, video, and/or another non-text-based content item. A speech-recognition technique, optical character recognition (OCR) technique, and/or other technique for extracting text from other types of data can be used to convert content item 222 into a text-based format before content item 222 is translated.

In some embodiments, a user specifies content item 222 within user interface 208 as a location of content item 222 in a corresponding content source. For example, the user includes a creator of content item 222, a moderator of content in the content source, a user responsible for managing translations of content in the content source, and/or another user with access rights to content item 222 and/or other content in the content source. The user interacts with a file manager and/or another type of user-interface element to specify a path to a file containing content item 222 within user interface 208. Alternatively or additionally, the user provides text 238 from content item 222 within user interface 208. For example, the user types or pastes text 238 from content item 222 into a text field in user interface 208.

Because configuration apparatus 202 is able to access and retrieve content from various content sources, configuration apparatus 202 and/or user interface 208 support selection of content item 222 from any of the content sources. For example, configuration apparatus 202 and/or user interface 208 allow users to browse, search, filter, discover, and/or select content sources and/or content in the content sources. User interface 208 also includes drop-down menus, text fields, and/or other user-interface elements that allow the users to select, identify, and/or copy and paste one or more content items to be translated.

Languages 224 include a source language of content item 222 and/or one or more destination languages into which content item 222 is to be translated. For example, user interface 208 includes checkboxes, drop-down menus, and/or other user-interface elements that allow the users to select one or more destination languages 224 and/or locales used in translating content item 222.

Priority 226 includes a rating, score, and/or other indication of the importance of the translation of content item 222. For example, a user interacting with user interface 208 may set priority 226 to “high” if translation of content item 222 is time-sensitive, content item 222 is important, and/or a large number of users interact with or use content item 222. Conversely, the user may set priority 226 to “normal” or “low” if translation of content item 222 is less time-sensitive, content item 222 is less important, and/or fewer users interact with or use content item 222.

Translation method 228 identifies the type of translation to be performed. For example, translation method 228 is specified as human translation or machine translation. In another example, translation method 228 includes a translation platform (e.g., translation system 206), type of human translation (e.g., a professional translator with one or more translation certifications, a contractor that is not required to have a translation certification, etc.), and/or type of machine translation (e.g., a machine learning model used to perform the translation).

After parameters 230 are submitted by a user through user interface 208, processing apparatus 204 formats parameters 230 into a translation request 210 that can be processed by translation system 206. For example, processing apparatus 204 validates parameters 230 for compliance with a schema for translation request 210. During such validation, processing apparatus 204 verifies that all required fields in the schema are found in translation request 210.

Processing apparatus 204 also, or instead, applies a number of validation rules to parameters 230 to ensure that translation request 210 complies with policies, laws, and/or regulations related to translating content. For example, processing apparatus 204 retrieves a configuration file containing the validation rules from a data store available to the system. Processing apparatus 204 obtains, from the configuration file, one or more validation rules that specify budget constraints for the content item (e.g., a maximum spending on a translation for the type of content in content item 222) and verifies that translation method 228 falls within the budget constraints (e.g., the cost of translating content item 222 using the selected translation method 228 does not exceed the maximum spending). Processing apparatus 204 also, or instead, obtains one or more validation rules specifying requirements related to translating certain types of content. When the content type of content item 222 is associated with one or more of these requirements, processing apparatus 204 verifies that parameters 230 of translation request 210 meet the requirements and/or sets parameters 230 to meet the requirements (e.g., when content item 222 is associated with a content type of “legal,” priority 226 is set to “high” and translation method 228 is set to “human”).

In one or more embodiments, processing apparatus 204 includes functionality to select translation method 228 for content item 222 (e.g., when a user-specified translation method 228 is not received via user interface 208) and/or override a user-specified translation method 228 (e.g., when validation of translation request 210 indicates that translation method 228 cannot be used with content item 222). In these embodiments, processing apparatus 204 selects translation method 228 based on parameters 230 of translation request 210 and/or attributes of content item 222.

For example, processing apparatus 204 sets translation method 228 to align with priority 226, so that a higher priority 226 translation request 210 utilizes human translation and/or a lower priority 226 translation request 210 utilizes machine translation. In another example, processing apparatus 204 sets translation method 228 to reflect the popularity or importance of content item 222, so that a more popular or important content item 222 (e.g., content with views or user interactions that exceeds a threshold and/or content that is flagged by creators or moderators as contributing to core functionality of an application or platform) utilizes human translation, while a less popular or important content item 222 utilizes machine translation. In a third example, processing apparatus 204 sets translation method 228 based on the type of content (e.g., legal, marketing, advertising, help center, blog, etc.) associated with content item 222 (e.g., as specified by a creator, reviewer, and/or moderator of content item 222) and/or attributes of text within content item 222 (e.g., topics, themes, keywords, sentiments, vocabulary, sentence structure, etc. in content item 222). In a fourth example, processing apparatus 204 selects translation method 228 based on the availability of human or machine translation for the source and destination languages 224 specified in translation request 210. In a fifth example, processing apparatus 204 inputs priority 226, the importance and/or popularity of content item 222, the type of content associated with content item 222, attributes of text in content item 222, and/or other features related to content item 222 and/or parameters 230 into a machine learning model, and the machine learning model outputs the best translation method 228 for the combination of inputted features.

Processing apparatus 204 then formats parameters 230, text 238 in content item 222, and/or one or more identifiers 218 in a representation of translation request 210 that can be used by an external translation system 206. For example, processing apparatus 204 adds unique identifiers 218 for content item 222, the content source of content item 222, translation request 210, the user requesting translation of content item 222, and/or other entities involved in translation of content item 222 as metadata to translation request 210. Processing apparatus 204 also adds values of parameters 230 (e.g., source and destination languages 224 for translating content item 222, priority 226, translation method 228, etc.) and text 238 to be translated from content item 222 as fields of structured data in translation request 210.

Processing apparatus 204 additionally converts translation request 210 into a format that is accepted by translation system 206. For example, processing apparatus 204 stores identifiers 218, parameters 230, text 238, and/or other fields in translation request 210 in a file or data interchange format that can be read by translation system 206. Processing apparatus 204 also, or instead, converts a text-based representation of identifiers 218, parameters 230, and text 238 into a compressed file that is accepted as input into translation system 206.

Processing apparatus 204 then submits translation request 210 to translation system 206 and tracks a status 214 of translation request 210 in translation system 206. For example, processing apparatus 204 and/or another component schedule recurring (e.g., hourly) events that query or poll translation system 206 for updates to status 214. The component maintains a record of status 214 and allows status 214 to be viewed and/or accessed through user interface 208, the content sources, and/or other components or systems that are separate from translation system 206.

After translation system 206 updates status 214 to indicate that processing of translation request 210 is complete (e.g., after a human or machine translator has produced a translation 232 of content item 222 according to parameters 230), processing apparatus 204 retrieves a result 216 of translation request 210 from translation system 206. Processing apparatus 204 then obtains translation 232 of content item 222 from result 216 and produces a response 212 that includes translation 232 and one or more identifiers 220 that provide context for translation 232. For example, processing apparatus 204 includes, in response 212, identifiers 220 of content item 222, a path to content item 222 in a corresponding content source, translation request 210, the user requesting translation of content item 222, and/or other entities involved in translation of content item 222 to allow response 212 to be matched to translation request 210. Identifiers 220 also, or instead, include a path, directory, or another location at which translation 232 is to be stored. Processing apparatus 204 also includes text from translation 232 in response 212 (e.g., in a format that can be processed by configuration apparatus 202 and/or the content source of content item 222).

Finally, processing apparatus 204 transmits response 212 to configuration apparatus 202, the content source of content item 222, and/or other components or systems for review and/or use. For example, configuration apparatus 202 receives response 212 from processing apparatus 204 and displays translation 232 in user interface 208 to allow the user that submitted translation request 210 and/or other users involved in managing or using content item 222 to review translation 232. After the user(s) approve translation 232, configuration apparatus 202 and/or the content source store translation 232 at a location (e.g., path, directory, etc.) that is optionally specified in an identifier in response 212 and/or with a Uniform Resource Name (URN) that is mapped to the language or locale of translation 232. The mapping, location, and/or URN are subsequently used to serve translation 232 from the location in response to resource requests (e.g., HyperText Transfer Protocol (HTTP) requests) for content item 222 that specify the same language or locale (e.g., in web cookies included in the resource requests).

The operation of the content localization framework of FIG. 2 can be illustrated using the following example. First, configuration apparatus 202 receives parameters 230 of translation request 210 from user interface 208 and stores parameters 230 in the following representation:

```
{
  “workflow” : “urn:workflow:f8ee0eed-c0b6-4e8d-a82e-bc96711f812e”,
  “contentIdentifier” : “urn:content:/draft/en-us/help/language-settings”,
  “contentPortions” : [
```

```
{
  “contentDescriptor”: “/pageSettings/pageTitle”,
  “content”: {
```

“htmlContent”: {
“content”: “Language Settings”
}

```
  }
},
{
  “contentDescriptor”: “/components/1/callout/headline”,
  “content”: {
```

“htmlContent”: {
“content”: “Keep in mind”
}

```
  }
},
{
  “contentDescriptor”: “/components/1/callout/description”,
  “content”: {
```

“htmlContent”: {
“content”: “If you select a language that isn't one of the supported

languages, your account will appear in your selected language
while the site will default to English.”

}

}
},

```
  ],
  “sourceLocale” : {
```

“language”: “en”,
“country”: “us”

```
  },
  “destinationLocales” : [
```

```
{
  “language”: “de”,
  “country”: “de”
}
```

```
  ],
  “translationType”: “MACHINE”,
  “priority”: “NORMAL”
}
```

The above representation includes unique identifiers 218 for translation request 210 (e.g., “urn:workflow”) and content item 222 (e.g., “urn:content”). Next, the representation includes different portions of text 238 in content item 222 (e.g., “contentPortions”). Each portion of text 238 includes a “contentDescriptor” with a path to the portion and/or other information related to the portion. Each portion also includes a “content” field that contains the actual text 238 to be translated by translation system 206.

The representation additionally includes a “sourceLocale” that specifies a country-specific language of the original content item 222 (e.g., a language of English that is specific to the country of the United States), as well as one or more “destinationLocales” that specify that a country-specific language of each translation of content item 222 (e.g., a language of German that is specific to the country of Germany) Finally, the representation includes fields that specify machine translation for translation method 228 (i.e., “translationType”) and a normal priority 226 for the translation.

Next, processing apparatus 204 converts translation request 210 into a representation that is compatible with translation system 206. For example, processing apparatus 204 converts the JavaScript Object Notation (JSON) representation of translation request 210 above into an Extensible Markup language (XML) representation of translation request 210 that can be parsed by translation system 206. Processing apparatus 204 also compresses translation request 210 and/or other files related to translation request 210 into a ZIP file and transmits the ZIP file to translation system 206 as a submission of translation request 210.

Processing apparatus 204 also maintains a local record of translation request 210, which initially includes a “pending” status 214. The local record can be queried by configuration apparatus 202 and/or other components or systems to monitor status 214. Processing apparatus 204 additionally uses a scheduling service to schedule events that check translation system 206 for updates to status 214. When one of the scheduled events is triggered, processing apparatus 204 receives the latest value of status 214 from the event.

After translation system 206 has completed the translation of content item 222 based on parameters 230 specified in translation request 210 (e.g., machine translation, normal priority, a destination locale of German and Germany, etc.), translation system 206 updates status 214 to indicate that processing of translation request 210 is complete. Processing apparatus 204 subsequently receives the new status (e.g., from a scheduled event) and retrieves result 216 of translation request 210 from translation system 206. Result 216 includes a similar format to the representation of translation request 210 submitted to translation system 206 (e.g., zipped XML).

Translation system 206 generates response 212 from result 216 in a format that is compatible with configuration apparatus 202, user interface 208, and/or the content source. In turn, response 212 includes the following JSON representation:

```
{
  “workflow”: “urn:workflow:f8ee0eed-c0b6-4e8d-a82e-bc96711f812e”,
  “contentIdentifier”: “urn:content:/content/draft/en-us/help/language-settings”,
  “contentPortions”: [
```

{
“contentDescriptor”: {

“string”: “/pageSettings/pageTitle”

```
  },
  “HtmlContent”: {
```

“HtmlContent”: {
“content”: “ Spracheinstellungen für Sales Navigator”
}

```
  }
},
{
  “contentDescriptor”: {
```

“string”: “/components/1/callout/headline”

```
  },
  “HtmlContent”: {
```

“HtmlContent”: {
“content”: “Hinweis:”
}

```
  }
},
{
  “contentDescriptor”: {
```

“string”: “/components/1/callout/description”

```
  },
  “HtmlContent”: {
```

“HtmlContent”: {
“content”: “Wenn Sie eine Sprache auswählen, die nicht zu den

unterstützten gehört Sprachen wird Ihr Konto in der von Ihnen
ausgewählten Sprache angezeigt während die Seite
standardmäßig auf Englisch ist.”

}

}
},

```
  ],
  “toLocale”: {
```

```
“language”: {
  “string”: “de”
},
“country”: {
  “string”: “de”
}
```

}
}

The above representation includes identifiers 220 for translation request 210 (e.g., “urn:workflow”) and content item 222 (e.g., “urn:content”) that are set to the same values as identifiers 218 in translation request 210. The representation also includes the same portions of content item 222 (e.g., “contentPortions”) as those found in translation request 210. Like translation request 210, each portion includes a “contentDescriptor” with a path to the portion and/or other information related to the portion. Unlike translation request 210, the “content” field in each portion of the above representation of response 212 includes a German translation 232 of the English text 238 found in the original content item 222.

Finally, processing apparatus 204 provides response 212 to configuration apparatus 202 and/or the content source for content item 222. Configuration apparatus 202 displays translation 232 in user interface 208 to allow users involved in producing or translating content item 222 to review, approve, and/or reject translation 232. After translation 232 is reviewed and approved (or if automatic approval of translation 232 is enabled), the content source stores translation 232 in a directory representing the locale that includes the country of Germany and the language of German Translation 232 is then served from the directory in response to subsequent resource requests for content item 222 that include the same locale.

By integrating with different types of content sources and translation systems, the content localization framework of FIG. 2 standardizes and automates the process of translating content from the content sources. Users are thus able to request and receive translations without interacting with and/or understanding how to use the translation systems. In turn, the content localization framework allows translations to be performed more quickly than conventional techniques that involve interacting with human translation managers and/or learning to use individual translation systems. The content localization framework further reduces utilization of processor, memory, storage, network, and/or other resources by conventional techniques that locate and manually retrieve content from a content source and/or require extensive human interaction with translation systems to generate translation requests that can be processed by the translation systems. Consequently, the disclosed embodiments improve computer systems, applications, user experiences, tools, and/or technologies related to storing, processing, querying, managing, and/or translating content.

Those skilled in the art will appreciate that the system of FIG. 2 may be implemented in a variety of ways. First, configuration apparatus 202, processing apparatus 204, content sources, and/or translation system 206 may be provided by a single physical machine, multiple computer systems, one or more virtual machines, a grid, one or more clusters, one or more databases, one or more filesystems, and/or a cloud computing system. Configuration apparatus 202 and processing apparatus 204 may be implemented together and/or separately by one or more hardware and/or software components and/or layers.

Second, the system may be adapted to different types or combinations of content sources and/or translation systems. For example, the content localization framework includes functionality to “onboard” additional content sources, which allows users that create, upload, or manage content in the content sources to send content and/or translation requests to the content localization framework. In another example, the content localization framework can be adapted to interface with different external translation systems, which allows translation requests to be submitted by users in a platform-agnostic manner and processed by any of the translation systems.

Third, data used by the system may be stored, defined, and/or transmitted using a number of techniques. For example, configuration apparatus 202 may retrieve content in different formats from different types of content sources, including CMSes, web feeds, websites, content distribution platforms, relational databases, graph databases, data warehouses, distributed filesystems, and/or flat files. In another example, processing apparatus 204 creates and/or transmits translation requests to translation system 206 and/or other translation systems in a number of formats, including database records, property lists, XML documents, JSON objects, and/or other types of structured data.

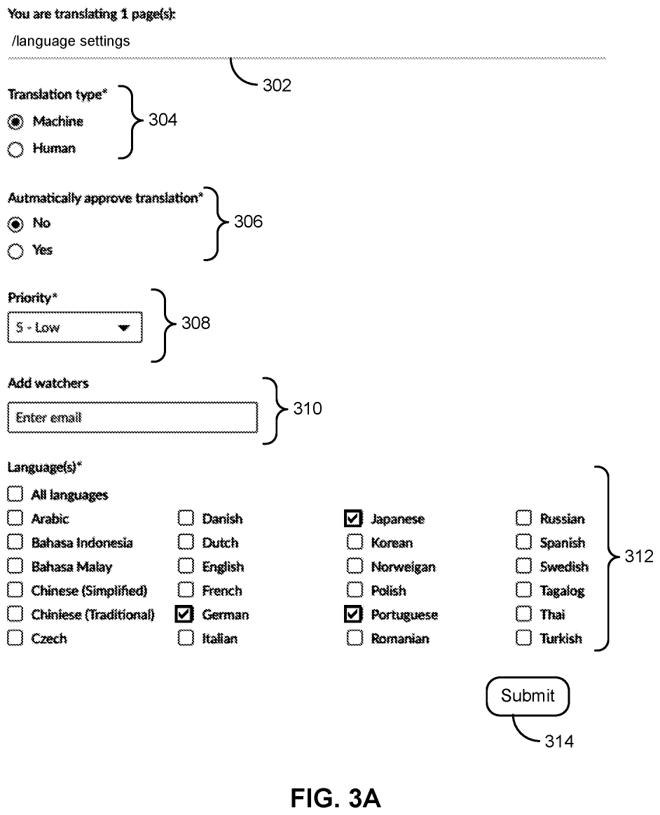

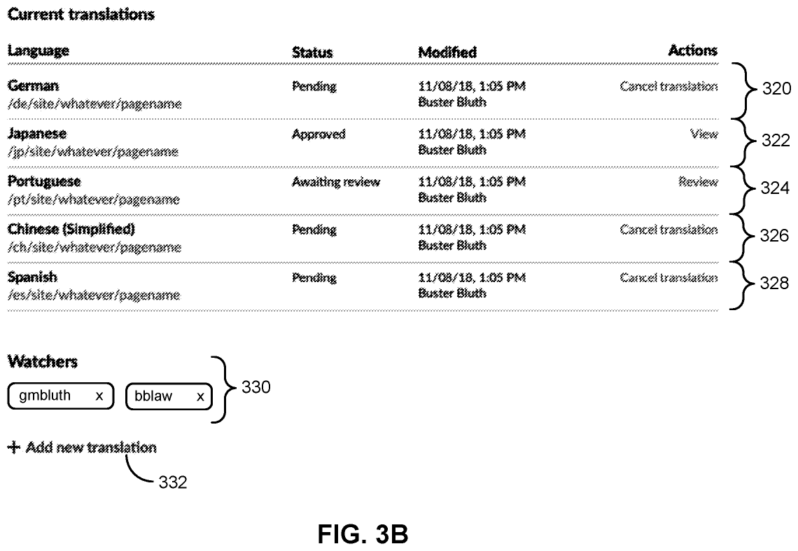

FIG. 3A shows an example screenshot in accordance with the disclosed embodiments. More specifically, FIG. 3A shows a screenshot of a user interface for creating a translation request, such as user interface 208 of FIG. 2. The user interface can be accessed within a content management system and/or a content localization framework that processes or manages requests to translate content.

As shown in FIG. 3A, the user interface includes a number of user-interface elements 302-314 for specifying parameters (e.g., parameters 230 of FIG. 2) of the translation request. User-interface element 302 includes a text field, file manager, and/or another component that allows a user to browse, search for, filter, and/or select one or more content items to be translated. User-interface element 304 includes two radio buttons for specifying human or machine translation of the content item(s).

User-interface element 306 includes two radio buttons for enabling or disabling automatic approval of the translation. For example, user-interface element 306 allows a user to specify whether human review and approval of the translation are required before the translation is used.

User-interface element 308 includes a drop-down menu for selecting a priority of the translation request, and user-interface element 310 includes a text field and/or another component that allows the users to specify email addresses of human “watchers” involved in monitoring or managing the translation. Email addresses entered into user-interface element 310 are “subscribed” to notifications of changes in status of the translation request and/or granted permission to access a record of the translation request, which can include the original content item(s), translations of the content item(s), and/or values of parameters in the translation request.

User-interface element 312 includes a number of checkboxes that can be used to select one or more destination languages into which the content item(s) are translated. Finally, user-interface element 314 includes a button that can be clicked to submit the translation request, after parameters of the translation request have been defined using elements 302-312.

FIG. 3B shows an example screenshot in accordance with the disclosed embodiments. More specifically, FIG. 3B shows a screenshot of a user interface for monitoring statuses of translation requests managed by a content localization framework, such as user interface 208 of FIG. 2. Like the screen of FIG. 3A, the screen of FIG. 3B can be accessed from a user interface for a content management system and/or the content localization framework.

The user interface of FIG. 3B includes a table containing information related to multiple translation requests 320-328. Each translation request includes a language of the translation (e.g., “German,” “Japanese,” “Portuguese,” “Chinese (Simplified)”, “Spanish”) and a path associated with the translation (e.g., “/de/site/whatever/pagename,” etc.). A user (e.g., a user that created one or more translation requests 320-328, an author of content to be translated using translation requests 320-328, a moderator of content in a content management system and/or a content localization framework, a user responsible for managing or overseeing translations of the content, etc.) can click on the language and/or path to view additional information related to the corresponding translation request (e.g., parameters of the translation request, the user that submitted the translation request, the time of the translation request, the content item to be translated, etc.).

Each translation request also includes a status that is set to “Pending,” “Approved,” or “Awaiting Review.” A “Pending” status indicates that the translation request has been submitted but has not been processed completely, an “Awaiting Review” status indicates that the translation request has been completed and the resulting translation is ready for human review, and an “Approved” status indicates that the translation request has been completed and the resulting translation has been approved.

Each translation request also includes a date and time of the most recent modification to the translation request (e.g., “11/08/18, 1:05 PM”), as well as a user that made the modification (e.g., “Buster Bluth”). Finally, each translation request includes an action that can be performed, given the status of the translation request. A “Pending” status includes a “Cancel translation” action, an “Approved” status includes a “View” action, and an “Awaiting review” status includes a “Review” action. A user can click on the action to access additional components or screens of the user interface for performing the action.

The user interface of FIG. 3B is also updated to reflect changes in status of translation requests 320-328. For example, after processing of a translation request by an external translation system is complete, the “Pending” status of the translation request is changed to “Awaiting review” (e.g., when human review of the translation is required) or “Approved” (e.g., when automatic approval of the translation is enabled). In another example, the cancellation of a “Pending” translation request causes the status of the translation request to be changed to “Cancelled.” In a third example, the approval or rejection of a translation request that is “Awaiting Review” causes the status of the translation request to be changed to “Approved” or “Rejected.”

The user interface of FIG. 3B additionally includes a user-interface element 330 that displays email addresses or aliases of human watchers of translation requests 320-328. Element 330 also allows watchers to be added (e.g., via a text field or another component) or removed (e.g., by clicking on the “x” next to a given alias).

Finally, the user interface includes an element 332 that allows a new translation request to be added. Clicking on element 332 causes the user interface to navigate to or display the screen of FIG. 3A.

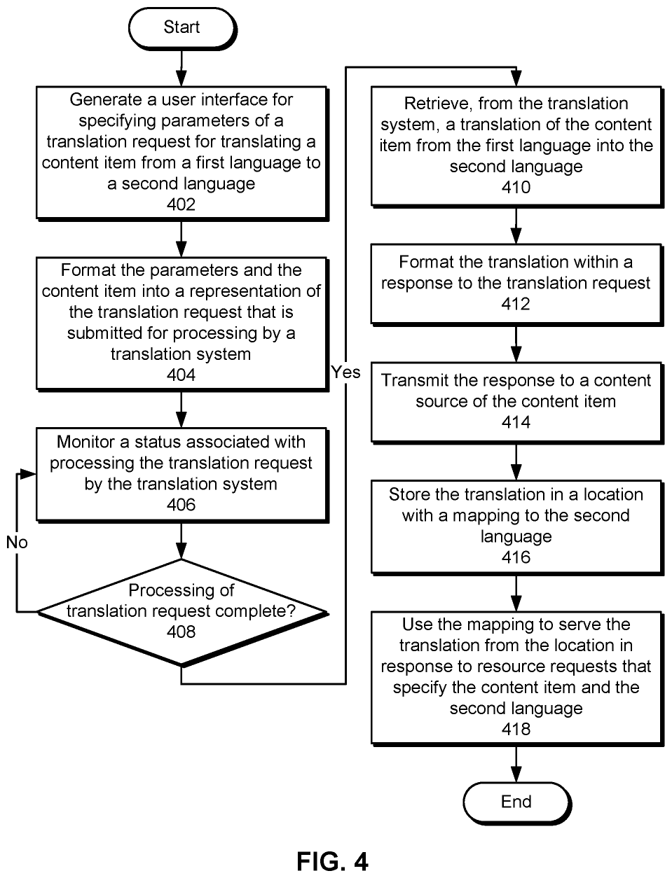

FIG. 4 shows a flowchart illustrating a process of managing the translation of content in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a user interface for specifying parameters of a translation request for translating a content item from a first language to a second language is generated (operation 402). For example, the user interface includes user-interface elements for selecting the content item within a CMS, external content source, and/or another source of content. In another example, the user interface includes user-interface elements for specifying the second language, a priority of the translation, a translation method (e.g., human, machine, type of human or machine, etc.), and/or other parameters of the translation request.

Next, the parameters and the content item are formatted into a representation of the translation request that is submitted for processing by a translation system (operation 404). For example, a translation method for translating the content item is optionally determined and/or overridden based on attributes of the content item. The attributes include, but are not limited to, the priority or popularity of the content item, the availability of the translation method for translating from the first language into the second language, the cost of the translation method, the type of content associated with the content item, and/or an attribute of text within the content item. The translation method is included in the parameters, and fields in the representation are populated with the parameters; one or more portions of the content item; and identifiers of the content item, translation request, and/or other entities associated with the translation request. The translation request is then generated in and/or converted into a format that is accepted by the translation system.

After the representation of the translation request is submitted to the translation system, a status associated with processing the translation request by the translation system is optionally monitored (operation 406) to detect completion of the translation system's processing of the translation request (operation 408). For example, one or more events are scheduled to check the translation system for updates to the status on a periodic basis and/or after a certain amount of time has passed (e.g., a number of hours or days representing the expected processing time associated with the translation method).

After the status indicates that processing of the translation request is complete, a translation of the content from the first language into the second language is retrieved from the translation system (operation 410). For example, the translation is obtained from the translation system in an output format supported by the translation system.

The translation is formatted within a response to the translation request (operation 412). For example, the response is generated to include identifiers of the content item, translation request, and/or other entities associated with the translation request; one or more parameters associated with the original translation request; and/or a text-based representation of the translation of the content item. The response is also generated in and/or converted into a format that is accepted by the content source of the content item.

Finally, the response is transmitted to the content source of the content item (operation 414). For example, the response is sent to a CMS, an external content source, and/or the user that submitted the translation request. After the response is received, the translation is outputted in the user interface to the user that submitted the translation request and/or other users involved in creating, managing, or translating the content item. In turn, the user(s) can interact with the user interface to review, approve, reject, and/or otherwise modify the status of the translation.

After the translation is approved (or if automatic approval of the translation is specified in the parameters of the translation request), the translation is stored in a location with a mapping to the second language (operation 416). The mapping is then used to serve the translation form the location in response to resource requests that specify the content item and the second language (operation 418). For example, the translation is stored in a directory and/or using a URN for the content item that includes an indication of the second language. When the second language is found in an HTTP request for the content item, a mapping and/or formula are used to convert the second language and/or path of the content item into the directory and/or URN. The content is then retrieved from the directory and/or using the URN and returned in response to the HTTP request.

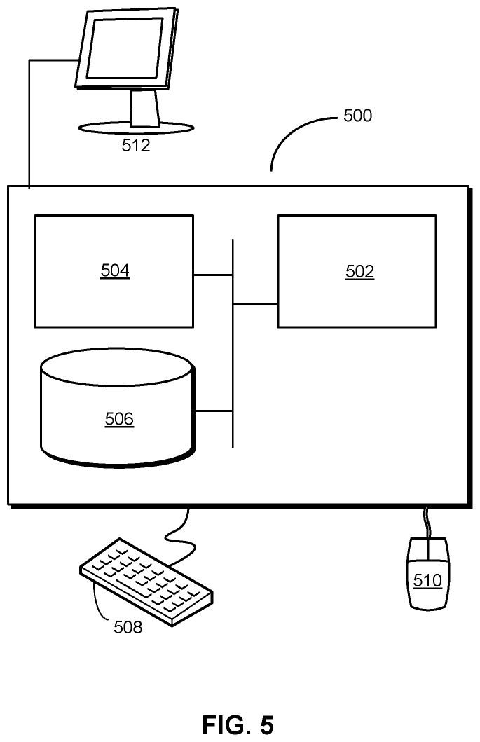

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for managing the translation of content. The system includes a configuration apparatus and a processing apparatus, one or more of which may alternatively be termed or implemented as a module, mechanism, or other type of system component. The configuration apparatus generates a user interface for specifying parameters of a translation request for translating a content item from a first language into a second language. The processing apparatus formats the parameters and the content item into a representation of the translation request that is submitted for processing by a translation system. The processing apparatus then monitors a status associated with processing the translation request by the translation system. Upon verifying completion of the translation request by the translation system, the processing apparatus retrieves, from the translation system, a translation of the content item from the first language into the second language. Finally, the processing apparatus formats the translation within a response to the translation request and transmits the response to a content source of the content item.

In addition, one or more components of computer system 500 may be remotely located and connected to the other components over a network. Portions of the present embodiments (e.g., configuration apparatus, processing apparatus, content sources, translation system, CMS, etc.) may also be located on different nodes of a distributed system that implements the embodiments. For example, the present embodiments may be implemented using a cloud computing system that manages the translation of content from a set of remote content sources and/or by a set of remote translation systems.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
generating a user interface for specifying parameters of a translation request for translating a content item from a first language into a second language;
formatting the parameters and the content item into a representation of the translation request that is submitted for processing by a translation system, wherein the representation comprises a first format that is accepted by the translation system;
monitoring a status associated with processing the translation request by the translation system; and
upon verifying completion of the translation request by the translation system:
retrieving, from the translation system, a translation of the content item from the first language into the second language;
formatting the translation within a response to the translation request, wherein the response comprises a second format that is accepted by a content source of the content item; and
transmitting the response to the content source.

2. The method of claim 1, wherein formatting the parameters and the content item into the representation comprises:
determining a translation method for translating the content item based on attributes of the content item; and
including the translation method in the representation.

3. The method of claim 2, wherein the translation method comprises at least one of:
a human translation method; and
a machine translation method.

4. The method of claim 2, wherein the attributes comprise at least one of:
a priority of the content item;
a popularity of the content item;
an availability of the translation method for translating from the first language into the second language;
a type of content associated with the content item; and
an attribute of text within the content item.

5. The method of claim 1, further comprising:
storing the translation in a location with a mapping to the second language; and
using the mapping to serve the translation from the location in response to a resource request that includes the content item and the second language.

6. The method of claim 1, wherein generating the user interface for specifying the parameters of the translation request comprises:
outputting, in the user interface, one or more user-interface elements for selecting the content item within one or more content sources.

7. The method of claim 6, wherein the one or more content sources comprise at least one of:
a content management system; and
an external content source.

8. The method of claim 1, wherein formatting the parameters and the content item into the representation of the translation request comprises:
adding one or portions of the content item, the parameters, and one or more identifiers as fields in the representation.

9. The method of claim 8, wherein the one or more identifiers represent at least one of:
the content item; and
the translation request.

10. The method of claim 1, wherein formatting the parameters and the content item into the representation of the translation request comprises:
converting the translation request into the first format.

11. The method of claim 1, wherein the parameters comprise at least one of:
the second language;
a translation method; and
a priority.

12. The method of claim 1, wherein the status comprises at least one of:
pending;
cancelled;
awaiting review;
approved; and
rejected.

13. A system, comprising:
one or more processors; and
memory storing instructions that, when executed by the one or more processors, cause the system to:
generate a user interface for specifying parameters of a translation request for translating a content item from a first language into a second language;
format the parameters and the content item into a representation of the translation request that is submitted for processing by a translation system, wherein the representation comprises a first format that is accepted by the translation system;
monitor a status associated with processing the translation request by the translation system; and
upon verifying completion of the translation request by the translation system:
retrieve, from the translation system, a translation of the content item from the first language into the second language;
format the translation within a response to the translation request, wherein the response comprises a second format that is accepted by a content source of the content item; and
transmit the response to the content source.

14. The system of claim 13, wherein the memory further stores instructions that, when executed by the one or more processors, cause the system to:
store the translation in a location with a mapping to the second language; and
use the mapping to serve the translation from the location in response to a resource request that includes the content item and the second language.

15. The system of claim 13, wherein formatting the parameters and the content item into the representation comprises:
selecting a translation method for translating the content item based on attributes of the content item, wherein the translation method comprises human translation or machine translation; and
including the translation method in the representation.

16. The system of claim 15, wherein the attributes comprise at least one of:
a priority of the content item;
a popularity of the content item;
an availability of the translation method for translating from the first language into the second language;
a type of content associated with the content item; and
an attribute of text within the content item.

17. The system of claim 13, wherein formatting the parameters and the content item into the representation of the translation request comprises:
adding one or portions of the content item, the parameters, and one or more identifiers as fields of structured data in the representation; and
converting the translation request into the first format.

18. The system of claim 13, wherein the parameters comprise at least one of:
the second language;
a translation method; and
a priority.

19. A non-transitory computer-readable storage medium storing instructions that when executed by a computer cause the computer to perform a method, the method comprising:
generating a user interface for specifying parameters of a translation request for translating a content item from a first language into a second language;
formatting the parameters and the content item into a representation of the translation request that is submitted for processing by a translation system, wherein the representation comprises a first format that is accepted by the translation system;
monitoring a status associated with processing the translation request by the translation system; and
upon verifying completion of the translation request by the translation system:
retrieving, from the translation system, a translation of the content item from the first language into the second language;
formatting the translation within a response to the translation request, wherein the response comprises a second format that is accepted by a content source of the content item; and
transmitting the response to the content source.

20. The non-transitory computer-readable storage medium of claim 19, the method further comprising:
storing the translation in a location with a mapping to the second language; and
using the mapping to serve the translation from the location in response to a resource request that includes the content item and the second language.
